(19) United States
(12) Patent Application Publication
(10) Pub. No.: US 2019/0280310 A1
(43) Pub. Date: Sep. 12, 2019

(54) IrRu AND IrPdRu ALLOY CATALYSTS

(71) Applicant: CORNELL UNIVERSITY, Ithaca, NY (US)

(72) Inventors: Hongsen WANG, Ithaca, NY (US); Héctor D. ABRUÑA, Ithaca, NY (US)

(73) Assignee: CORNELL UNIVERSITY, Ithaca, NY (US)

(21) Appl. No.: 16/462,078

(22) PCT Filed: Nov. 20, 2017
(86) PCT No.: PCT/US17/62536

§ 371 Date: May 17, 2019

Related U.S. Application Data
(60) Provisional application No. 62/424,143, filed on Nov. 18, 2016.

(51) Int. Cl. H01M 4/92; H01M 8/083; C22C 28/00

(52) U.S. Cl. CPC H01M 4/921; C22C 28/00; H01M 8/083

(57) ABSTRACT

Provided are alloys of formula (I), Ir_{z}PdₓRu_{y}, wherein x is the atomic % of palladium (Pd) present, y is the atomic % of ruthenium (Ru) present, Z is the atomic % of iridium (Ir) present, and 0≤x≤20, 10≤y≤90, and, 10≤z≤90. Electrocatalysts, devices, and processes employing the alloys are also provided.

### CROSS-REFERENCE TO RELATED APPLICATIONS

This application claims priority to U.S. Provisional Patent Application No. 62/424,143, filed Nov. 18, 2016, the disclosure of which is hereby incorporated by reference herein in its entirety.

### FIELD OF THE INVENTION

This invention relates to, inter alia, IrRu and IrPdRu (collectively, Ir(Pd)Ru) alloys, and to devices and methods employing the same, including fuel cells, for example, alkaline-exchange membrane fuel cells.

### BACKGROUND

Alkaline-exchange membrane fuel cells (AEMFCs, also known as anion exchange membrane fuel cells), which operate in basic media, have the potential to exhibit higher efficiencies and better performance than proton exchange membrane fuel cells (PEMFCs), which operate in an acidic environment, in that the oxygen reduction reaction (ORR) kinetics can be significantly enhanced. However, while in acid media H₂ oxidation kinetics on platinum (Pt) are very facile, in alkaline media, H₂ oxidation kinetics on Pt are very sluggish, being over 100 times slower than in acidic media. Other Pt-group metals also exhibit a similar trend when going from acidic media to alkaline media. Thus, a need exists for improved materials to better enable AEMFCs as viable alternatives to other commercial fuel cells, such as PEMFCs.

While certain aspects of conventional technologies have been discussed to facilitate disclosure of the invention, Applicant in no way disclaims these technical aspects, and it is contemplated that the claimed invention may encompass one or more of the conventional technical aspects discussed herein.

In this specification, where a document, act or item of knowledge is referred to or discussed, this reference or discussion is not an admission that the document, act or item of knowledge or any combination thereof was, at the priority date, publicly available, known to the public, part of common general knowledge, or otherwise constitutes prior art under the applicable statutory provisions; or is known to be relevant to an attempt to solve any problem with which this specification is concerned.

### SUMMARY OF THE INVENTION

Briefly, the present invention satisfies the need for improved materials to improve and better enable AEMFCs.

The invention provides, inter alia, IrRu and IrPdRu alloys, and devices and methods employing the same. The alloy materials find non-limiting use as H₂ oxidation reaction (HOR) catalysts in fuel cells, such as AEMFCs.

It has been reported that IrPd/C catalysts have a comparable activity for HOR to Pt/C in alkaline media. Ru/C is also reported to be quite active for the HOR in alkaline media, and about 3 nm Ru nanoparticle catalyst is more active than Pt nanoparticles. A comparison of PtRu and PdRu alloys for the HOR in alkaline media determines that, while Ru alloying with Pt can significantly enhance the HOR kinetics, Ru alloying with Pd does not. Notwithstanding the finding that Ru alloying with Pd does not significantly enhance HOR kinetics, the Applicant has surprisingly discovered a new type of advantageous catalyst—Ir(Pd)Ru alloys as H₂ oxidation catalysts in alkaline media, which are much more active than Pt and Ir in alkaline media, and cost much less.

Embodiments of the invention may address one or more of the problems and deficiencies discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

Certain embodiments of the presently-disclosed alloy materials and related compositions, devices, and methods have several features, no single one of which is solely responsible for their desirable attributes. Without limiting the scope of the alloy materials and related compositions, devices and processes as defined by the claims that follow, their more prominent features will now be discussed briefly. After considering this discussion, and particularly after reading the section of this specification entitled “Detailed Description of the Invention,” one will understand how the features of the various embodiments disclosed herein provide a number of advantages over the current state of the art. These advantages may include, without limitation, providing alloys and compositions that have enhanced electrocatalytic activity toward HOR, providing alloys, compositions, and devices having improved HOR kinetics, providing low or lower cost catalysts (e.g., as compared to commercial catalysts such at Pt catalysts), providing improved fuel cells, providing improved alkaline-exchange membrane fuel cells, providing improved anode catalysts for fuel cell (e.g., AEMFC) applications, etc.

In a first aspect, the invention provides an alloy comprising:
10 to 90 atomic % iridium (Ir);
0 to 20 atomic % palladium (Pd); and
10 to 90 atomic % ruthenium (Ru).

In a second aspect, the invention provides an electrocatalyst comprising the alloy according to the first aspect of the invention.

In a third aspect, the invention provides a device comprising the alloy according to the first aspect of the invention or the electrocatalyst according to the second aspect of the invention.

In a fourth aspect, the invention provides an electrocatalytic process, wherein said process comprises use of the alloy according to the first aspect of the invention or the electrocatalyst according to the second aspect of the invention.

These and other objects, features, and advantages of this invention will become apparent from the following detailed description of the various aspects of the invention taken in conjunction with the accompanying drawings.

### BRIEF DESCRIPTION OF THE DRAWINGS

The present invention will hereinafter be described in conjunction with the following drawing figures. The depicted figures serve to illustrate various embodiments of the invention. However, the invention is not limited to the precise arrangements and instrumentalities of the embodiments depicted in the drawings.

FIG. 1 is a simplified schematic of an embodiment of an AEMFC, which is intended for ease of understanding, and is not intended to be drawn to scale or stoichiometrically accurate.

FIGS. 2A-D depict XRD patterns of Ir/C, Ru/C, IrRu/C, IrPd/C and IrPdRu/C catalyst embodiments. The inset of each figure shows the enlarged region of (220) and (110) diffraction peaks. The vertical lines indicate the peak positions of Ir (PDF card #00-006-0598), and Ru (PDF card #00-006-0663).

FIG. 3 depicts RDE voltammograms of Pt/C, Pd/C, Ir/C and Ru/C catalysts in H₂ saturated 0.1 M KOH. Scan rate: 5 mV/s, rotation rate: 1600 rpm. The catalyst loading is 3.5 μgₘₑₜₐₗ/cm².

FIGS. 4A and 4B depict cyclic voltammograms of Ir/C, Ru/C and a series of Ir(Pd)Ru/C catalyst embodiments in 0.1 M KOH. The catalyst loading is 3.5 μgₘₑₜₐₗ/cm². Scan rate: 50 mV/s.

FIGS. 5A and 5B depict RDE voltammograms of Ir/C and Ir(Pd)Ru/C catalyst embodiments in H₂ saturated 0.1 M KOH. Scan rate: 5 mV/s, rotation rate: 1600 rpm. The catalyst loading is 3.5 μgₘₑₜₐₗ/cm².

FIGS. 6A-C depict comparison charts of HOR activity on Pt/C, Pd/C, Ir/C, Ru/C, and Ir(Pd)Ru/C catalyst embodiments in H₂ saturated 0.1 M KOH. The catalyst loading is 3.5 μgₘₑₜₐₗ/cm². “MA” is mass activity at 0.01 V vs. RHE; “SA” is specific activity at 0.01 V vs. RHE; “ECD” is exchange current density.

### DETAILED DESCRIPTION OF THE INVENTION

The present invention relates to, inter alia, IrRu and IrPdRu alloy materials, and to devices and processes employing the same, including fuel cells, e.g., AEMFCs.

Aspects of the present invention and certain features, advantages, and details thereof are explained more fully below with reference to the non-limiting embodiments discussed and illustrated in the accompanying drawings. Descriptions of well-known materials, fabrication tools, processing techniques, etc., are omitted so as to not unnecessarily obscure the invention in detail. It should be understood, however, that the detailed description and the specific examples, while indicating embodiments of the invention, are given by way of illustration only, and not by way of limitation. Various substitutions, modifications, additions and/or arrangements within the spirit and/or scope of the underlying inventive concepts will be apparent to those skilled in the art from this disclosure.

In a first aspect, the invention provides an alloy comprising:
10 to 90 atomic % iridium (Ir);
0 to 20 atomic % palladium (Pd); and
10 to 90 atomic % ruthenium (Ru).

As is known in the art, an alloy is a mixture of the elements comprised within it.

In some embodiments, the elements in the alloy are homogeneously mixed.

In some embodiments, the alloy is a single phase.

Also as known in the art, atomic % (at. %) refers to the percentage of one kind of atom relative to the total number of atoms present in the alloy.

The alloy comprises 10 to 90 atomic % iridium (Ir) (e.g., 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90 atomic %), including any and all ranges and subranges therein (e.g., 20 to 80 at. %, 30 to 60 at. %, etc.).

The alloy comprises 0 to 20 atomic % palladium (Pd) (e.g., 0, 1, 2, 3, 4, 5, 6, 7, 8, 9, 10, 11, 12, 13, 14, 15, 16, 17, 18, 19, or 20 atomic %), including any and all ranges and subranges therein (e.g., 1 to 20 at. %, 2 to 20 at. %, 3 to 20 at. %, 4 to 20 at. %, 5 to 20 at. %, 5 to 15 at. %, etc.).

The alloy comprises 10 to 90 atomic % ruthenium (Ru) (e.g., 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90 atomic %), including any and all ranges and subranges therein (e.g., 20 to 80 at. %, 30 to 60 at. %, etc.).

In some embodiments, the sum of the atomic percentages of Ir, Pd, and Ru in the alloy is greater than or equal to 90 atomic % of the alloy (e.g., greater than or equal to 91, 92, 93, 94, 95, 96, 97, 98, 99, 99.5, or 99.9 atomic % of the alloy).

In some embodiments, the alloy comprises:
10 to 90 atomic % iridium (Ir);
0 to 20 atomic % palladium (Pd);
10 to 90 atomic % ruthenium (Ru); and
less than 2 atomic % of one or more additional elements.

In some embodiments, the one or more additional elements are selected from metals and transition metals. In some embodiments, the alloy comprises one or more additional elements, such as platinum, osmium, rhodium, titanium, cobalt, chromium, manganese, iron, nickel, copper, zinc, molybdenum, tungsten, other transition metals or combinations thereof. In some embodiments, the one or more additional elements do not comprise platinum. In some embodiments, the one or more additional elements do not comprise copper.

In some embodiments, other trace elements could exist in the alloy or be added into the alloy.

In some embodiments, the alloy is an alloy of formula (I):

Ir_{z}PdₓRu_{y} (I),

wherein x is the atomic % of Pd present, y is the atomic % of Ru present, z is the atomic % of iridium (Ir) present, and:
0≤x≤20;
10≤y≤90; and
10≤z≤90.

In embodiments of the inventive alloy according to formula (I), x+y+z=100.

In some embodiments, the invention provides an alloy having the formula (Ia):

Ir_{z}Ru_{y} (Ia).

In embodiments of the inventive alloy according to formula (Ia), y+z=100.

In some embodiments, the invention provides an alloy of formula (I), wherein:

the atomic % of Pd (x) present is 0 to 20 (e.g., 0, 1, 2, 3, 4, 5, 6, 7, 8, 9, 10, 11, 12, 13, 14, 15, 16, 17, 18, 19, or 20 atomic %), including any and all ranges and subranges therein (e.g., 0.5 to 20 at. %, 1 to 20 at. %, 2 to 20 at. %, 2 to 15 at. %, 3 to 20 at. %, 4 to 20 at. %, 5 to 20 at. %, 5 to 15 at. %, 5 to 12 at. %, etc.);

the atomic % of Ru (y) present is 10 to 90 (e.g., 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90 atomic %), including any and all ranges and subranges therein (e.g., 10 to 80 at. %, 20 to 80 at. %, 30 to 80 at. %, 30 to 60 at. %, etc.) and

the atomic % of Ir (z) present is 10 to 90 (e.g., 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90 atomic %), including any and all ranges and subranges therein (e.g., 20 to 80 at. %, 30 to 70 at. %, 30 to 60 at. %, etc.).

In some embodiments, the atomic % of Pd (x) is greater than 5 at. %.

In some embodiments, the atomic % of Pd (x) present in the alloy is the range up to the solubility limit of Pd in Ir, Ru or IrRu alloy.

In some embodiments, the alloy has a face centered cubic (FCC) structure.

In some embodiments, the alloy is relatively high in Ir content (e.g., higher in Ir at. % than Ru at. %), and exhibits a FCC structure.

In some embodiments, the alloy comprises less than or equal to 40 at. % Ru (i.e., 10 to 40 at. %, e.g., 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40 at. %, including any and all ranges and subranges therein, e.g., less than or equal to 30 at. %).

In some embodiments, the alloy comprises less than or equal to 40 at. % (e.g., less than or equal to 30 at. %) Ru and has a FCC structure.

In some embodiments, the alloy has a hexagonal close packed (HCP) structure.

In some embodiments, the alloy is relatively high in Ru content (e.g., higher in Ru at. % than Ir at. %), and has a HCP structure.

In some embodiments, the alloy comprises less than or equal to 40 at. % Ir (i.e., 10 to 40 at. %, e.g., 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40 at. %, including any and all ranges and subranges therein, e.g., less than or equal to 30 at. %).

In some embodiments, the alloy comprises less than or equal to 40 at. % (e.g., less than or equal to 30 at. %) Ir and has a HCP structure.

In a second aspect, the invention provides an electrocatalyst comprising the alloy according to the first aspect of the invention.

The electrocatalyst can comprise any embodiment according to the first aspect of the invention, optionally in combination with properties of any other embodiment(s) according to the first aspect of the invention.

In some embodiments, the electrocatalyst is in the form of a nanoparticle (i.e., an electrocatalyst nanoparticle) comprising the alloy according to the first aspect of the invention.

In some embodiments, the electrocatalyst consists of the alloy according to the first aspect of the invention. For example, in some embodiments, the electrocatalyst consists of an alloy according to formula (I).

In some embodiments, the electrocatalyst is a single phase.

In some embodiments, the electrocatalyst has an FCC or HCP structure.

In some embodiments, the electrocatalyst is an electrocatalyst nanoparticle having a size of 2 to 20 nm (e.g., 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, 10.0, 10.1, 10.2, 10.3, 10.4, 10.5, 10.6, 10.7, 10.8, 10.9, 11.0, 11.1, 11.2, 11.3, 11.4, 11.5, 11.6, 11.7, 11.8, 11.9, 12.0, 12.1, 12.2, 12.3, 12.4, 12.5, 12.6, 12.7, 12.8, 12.9, 13.0, 13.1, 13.2, 13.3, 13.4, 13.5, 13.6, 13.7, 13.8, 13.9, 14.0, 14.1, 14.2, 14.3, 14.4, 14.5, 14.6, 14.7, 14.8, 14.9, 15.0, 15.1, 15.2, 15.3, 15.4, 15.5, 15.6, 15.7, 15.8, 15.9, 16.0, 16.1, 16.2, 16.3, 16.4, 16.5, 16.6, 16.7, 16.8, 16.9, 17.0, 17.1, 17.2, 17.3, 17.4, 17.5, 17.6, 17.7, 17.8, 17.9, 18.0, 18.1, 18.2, 18.3, 18.4, 18.5, 18.6, 18.7, 18.8, 18.9, 19.0, 19.1, 19.2, 19.3, 19.4, 19.5, 19.6, 19.7, 19.8, 19.9, or 20.0 nm), including any and all ranges and subranges therein (e.g., 2.5 to 20 nm, 2.8 to 15 nm, 3 to 15 nm, 2.5 to 6 nm, 2 to 5 nm, etc.).

In some embodiments, at least 99 wt % (e.g., at least 99.1, 99.2, 99.3, 99.4, or 99.5 wt %) of the nanoparticle consists of the total amount present of Ir, Ru, and, where present in the alloy, Pd.

In some embodiments, the invention provides a plurality of the electrocatalyst nanoparticles, wherein the particles have an average size of 2 to 20 nm (e.g., 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, 10.0, 10.1, 10.2, 10.3, 10.4, 10.5, 10.6, 10.7, 10.8, 10.9, 11.0, 11.1, 11.2, 11.3, 11.4, 11.5, 11.6, 11.7, 11.8, 11.9, 12.0, 12.1, 12.2, 12.3, 12.4, 12.5, 12.6, 12.7, 12.8, 12.9, 13.0, 13.1, 13.2, 13.3, 13.4, 13.5, 13.6, 13.7, 13.8, 13.9, 14.0, 14.1, 14.2, 14.3, 14.4, 14.5, 14.6, 14.7, 14.8, 14.9, 15.0, 15.1, 15.2, 15.3, 15.4, 15.5, 15.6, 15.7, 15.8, 15.9, 16.0, 16.1, 16.2, 16.3, 16.4, 16.5, 16.6, 16.7, 16.8, 16.9, 17.0, 17.1, 17.2, 17.3, 17.4, 17.5, 17.6, 17.7, 17.8, 17.9, 18.0, 18.1, 18.2, 18.3, 18.4, 18.5, 18.6, 18.7, 18.8, 18.9, 19.0, 19.1, 19.2, 19.3, 19.4, 19.5, 19.6, 19.7, 19.8, 19.9, or 20.0 nm), including any and all ranges and subranges therein (e.g., an average size of 2.5 to 20 nm, 2.8 to 15 nm, 3 to 15 nm, 2.5 to 6 nm, 2 to 5 nm, etc.).

In some embodiments, the electrocatalyst is supported on an electrically conductive carrier/support (e.g., conductive carbon black). Such embodiments can be referred to as conductive carrier-supported nanoparticle catalysts (e.g., carbon supported nanoparticle catalysts, which can be designated as, e.g., Ir(Pd)Ru/C).

In some embodiments, a plurality of electrocatalyst nanoparticles are supported on an electrically conductive carrier.

In some embodiments, the invention provides a catalyst for an anode of a fuel cell (e.g., an AEMFC), wherein the catalyst comprises the alloy according to the first aspect of the invention or the electrocatalyst according to the second aspect of the invention.

In some embodiments, the catalyst for an anode is supported on an electrically conductive carrier (e.g., carbon black). In such embodiments, the catalyst may be referred to as carrier-supported (e.g., carbon-supported).

In some embodiments, the electrocatalyst does not comprise any metal or transition metal elements in addition to those present in the inventive alloy (e.g., the alloy of formula (I)).

In some embodiments, the electrocatalyst has a particular mass activity (MA), specific activity (SA), and/or exchange current density (ECD). For example, in some embodiments, at 0.01 V, embodiments of the catalyst have:
an MA (mA/μgₘₑₜₐₗ²) of at least 0.13, 0.14, 0.15, 0.16, 0.17, 0.18, 0.19, 0.20, 0.21, 0.22, 0.23, 0.24, 0.25, 0.26, 0.27, 0.28, 0.29, 0.30, 0.31, 0.32, 0.33, 0.34, 0.35, 0.36, 0.37, or 0.38; and/or
a SA (mA/cmₘₑₜₐₗ²) of at least 0.08, 0.09, 0.10, 0.11, 0.12, 0.13, 0.14, 0.15, 0.16, 0.17, 0.18, 0.19, 0.20, 0.21, 0.22, 0.23, 0.24, 0.25, 0.26, 0.27, 0.28, 0.29, 0.30, 0.31, 0.32, 0.33, 0.34, 0.35, 0.36, 0.37, 0.38, 0.39, 0.40, 0.41, 0.42, 0.43, 0.44, or 0.45; and/or
an ECD (mA/cmₘₑₜₐₗ²) of at least 0.20, 0.21, 0.22, 0.23, 0.24, 0.25, 0.26, 0.27, 0.28, 0.29, 0.30, 0.31, 0.32, 0.33, 0.34, 0.35, 0.36, 0.37, 0.38, 0.39, 0.40, 0.41, 0.42, 0.43, 0.44, 0.45, 0.46, 0.47, 0.48, 0.49, 0.50, 0.51, 0.52, 0.53, 0.54, 0.55, 0.56, 0.57, 0.58, 0.59, 0.60, 0.61, 0.62, 0.63, 0.64, 0.65, 0.66, 0.67, 0.68, 0.69, 0.70, 0.71, 0.72, 0.73, 0.74, 0.75, 0.76, 0.77, 0.78, 0.79, 0.80, 0.81, 0.82, 0.83, 0.84, 0.85, 0.86, 0.87, 0.88, 0.89, or 0.90.

In some embodiments, the electrocatalyst has a half-wave potential (E_{1/2}) (in volts, V) of at least 0.015, 0.16, 0.17, 0.18, 0.19, 0.20, 0.21, 0.22, 0.23, 0.24, 0.25, 0.26, 0.27, 0.28, 0.29, 0.30, 0.31, 0.32, 0.33, or 0.34.

In a third aspect, the invention provides a device comprising the alloy according to the first aspect of the invention or the electrocatalyst according to the second aspect of the invention.

The device can comprise any embodiment according to the first aspect of the invention and/or the second aspect of the invention, optionally in combination with properties of any other embodiment(s) according to the first and/or second aspect of the invention.

In some embodiments, the device comprises two electrodes.

In some embodiments, the device is configured to transport hydroxide anions (OH⁻) from one electrode to the other.

In some embodiments, the device is a fuel cell.

In some embodiments, the device is a fuel cell, for example, an AEMFC, comprising an anode and a cathode, wherein at least one of the anode or the cathode comprises the alloy according to the first aspect of the invention or the electrocatalyst according to the second aspect of the invention.

AEMFCs are alkaline fuel cells that comprise a solid polymer electrolyte, i.e., an alkaline exchange membrane. Currently, the most popular commercialized fuel cells are proton exchange membrane fuel cells (PEMFCs). PEMFCs and AEMFCs both generate electricity, but PEMFCs operate in acidic media, and comprise a proton-conducting polymer electrolyte membrane, whereas AEMFCs operate in alkaline media and comprise an anion exchange membrane (AEM) that conducts anions (such as OH⁻). In addition to the fact that the solid membrane in AEMFCs is an alkaline AEM instead of an acidic PEM, AEMFCs can be further distinguished from PEMFCs in that, for AEMFCs, the AEM transports ions (e.g., hydroxide ions, OH⁻) from the cathode to the anode, whereas proton (H⁺) conduction in a PEMFC goes from anode to cathode. The use of the AEM in the AEMFC creates an alkaline pH cell environment, thereby attractively opening up the possibilities for, inter alia, enhanced oxygen reduction catalysis (which could allow for the use of less expensive, e.g., Pt-free catalysts), extended range of fuel cell materials to be used (e.g., stable in the AEMFC, but that may not have sufficient stability in an acidic environment), and different range of possible membrane materials.

Depending on, e.g., the cathode oxidant gas, different anions are present in different amounts during the operation of an AEMFC. For example, when ambient air is used, anions present during operation of the AEMFC can include HCO₃⁻, CO₃²⁻, and OH⁻. Typically though, when operated at high current densities, the most common anion species present across the AEM membrane is the hydroxide anion (OH⁻), initially present and also generated via electrochemical ORR at the cathode of the AEMFC.

During operation of an AEMFC, the OH⁻ is transported from the cathode to the anode. If hydrogen is used as fuel, the following oxidation reaction takes place at the anode:

2OH⁻+H₂→2H₂O+2e⁻

Thus, similar to PEMFCs, AEMFCs also produce water as a byproduct, but the water generated in an AEMFC is twice as much as in a PEMFC, per electron. Further, water is a reactant at the cathode.

The above discussion demonstrates various significant differences between AEMFCs and PEMFCs. Indeed, the alkaline environment and AEM, and different ORR and HOR mechanisms result in AEMFCs being significantly different from PEMFCs. Indeed, environmental and electrochemical differences between AEMFCs and PEMFCs are such that entirely different materials are used in the fuel cells, and materials useful for one type of fuel cell cannot be expected to be (and are often not) useful in the other. This point is exemplified, for example, by the fact that, while in acidic media H₂ oxidation kinetics on platinum (Pt) are very facile, in alkaline media, H₂ oxidation kinetics on Pt are very sluggish, being over 100 times slower than in acidic media. Thus, a need exists for improved materials that are specifically useful in alkaline conditions and for the development of improved AEMFCs. The Applicant has found that the alloys and catalysts described herein offer such use, including, for example, as new anode catalysts for AEMFCs.

In some embodiments, the invention provides an AEMFC comprising:
an anode comprising the alloy according to the first aspect of the invention or the electrocatalyst according to the second aspect of the invention;
a cathode; and
an alkaline exchange membrane (AEM) configured to transport anions from the cathode to the anode.

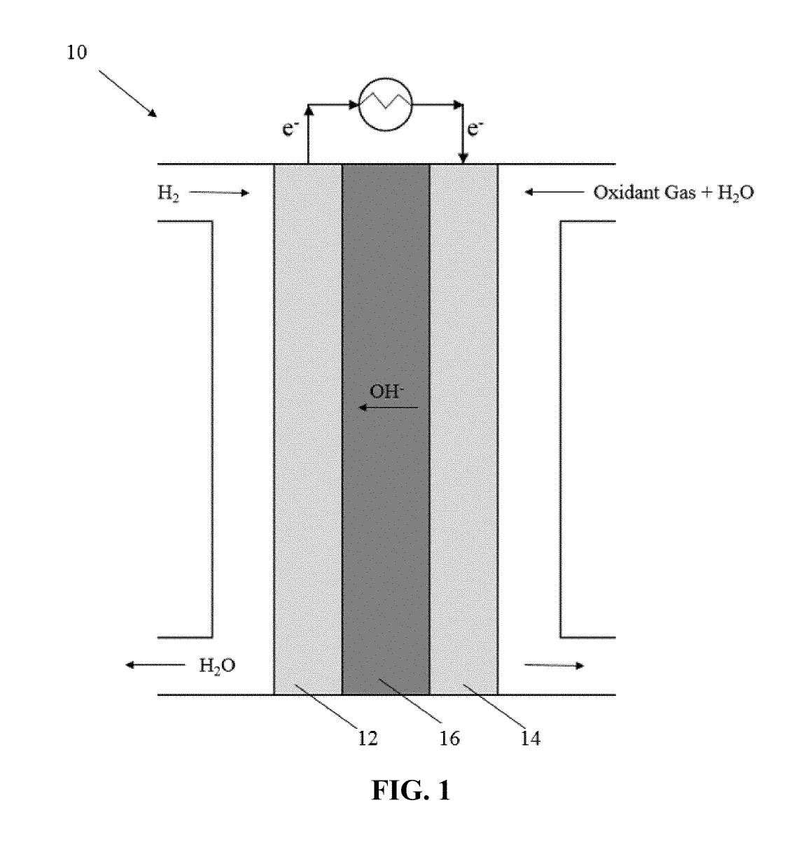

FIG. 1 is a simple schematic of an embodiment of an AEMFC 10. The schematic is for ease of reference and understanding; it is not necessarily drawn to scale, and, where reactants, anions, and products are shown, such illustration does not purport to convey accurate reaction stoichiometry. Referring to FIG. 1, AEMFC 10 comprises anode 12, cathode 14, and AEM 16.

In some embodiments, the anode comprises the inventive electrocatalyst, and the electrocatalyst is supported on an electrically conductive carrier (e.g., the catalyst is carbon-supported).

In some embodiments, the AEMFC anode does not comprise platinum and/or copper.

In some embodiments, the AEMFC does not comprise platinum and/or copper.

In some embodiments, the AEMFC is configured to use pure oxygen or air as a cathode oxidant gas. In some embodiments, the air is ambient air, CO₂-free air (also known as synthetic, or pure air), or CO₂-filtered air.

In some embodiments, the AEMFC is configured to use, as fuel, hydrogen or methanol. In particular embodiments, the AEMFC is configured to use hydrogen.

The AEM separates the anode and the cathode, and conducts OH⁻ ions from the cathode to the anode. The AEM may be any anion exchange membrane configured for use in an AEMFC.

In some embodiments, the AEM is a polymeric anion exchange membrane comprising cationic moieties that are fixed to or within polymeric chains (vs., e.g., a liquid electrolyte, within which the cationic moieties would be freely mobile). In some embodiments, the AEM comprises a polymer backbone having cationic groups incorporated therein (e.g., alkylated poly(benzimidazoles)). In some embodiments, the AEM comprises a polymer backbone having cationic groups pendant/tethered thereto. For example, in some embodiments, the AEM comprises a hydroxide-conducting functionalized polysulfone (e.g., functionalized via chloromethylation, followed by reaction with a phosphine or quaternization with an amine to yield a phosphonium or ammonium salt that can be alkalinized, e.g., with KOH, to yield a hydroxide-conducting AEM). In some embodiments, the AEM comprises a quaternary ammonium polysulfone. In some embodiments, the AEM is based on a xylylene ionene.

In some embodiments, the inventive device is an alkaline electrolyzer.

In some embodiments, the alkaline electrolyzer comprises two electrodes configured to operate in a liquid alkaline electrolyte solution (e.g., of potassium hydroxide or sodium hydroxide). In some embodiments, the electrodes are separated by a diaphragm that separates product gases and transports hydroxide ions from one electrode to the other.

In some embodiments, the alkaline electrolyzer is a nickel-based electrolyzer.

In some embodiments, the alkaline electrolyzer is a water electrolyzer.

In some embodiments, the inventive alloy or electrocatalyst is comprised within an electrode of the electrolyzer. In some embodiments, the inventive alloy or electrocatalyst is comprised within the anode of the electrolyzer. In some embodiments, the inventive alloy or electrocatalyst is comprised within the cathode of the electrolyzer.

In a fourth aspect, the invention provides an electrocatalytic process, wherein said process comprises use of the alloy according to the first aspect of the invention or the electrocatalyst according to the second aspect of the invention.

The electrocatalytic process can comprise use of any embodiment according to the first aspect of the invention and/or the second aspect of the invention, optionally in combination with properties of any other embodiment(s) according to the first and/or second aspect of the invention.

In some embodiments, the electrocatalytic process comprises operating a device according to the third aspect of the invention.

In some embodiments, the electrocatalytic process is performed at a pH>7.

In some embodiments, the electrocatalytic process comprises transporting OH⁻ ions from a cathode to an anode, wherein the anode comprises the alloy according to the first aspect of the invention or the electrocatalyst according to the second aspect of the invention.

In some embodiments, the electrocatalytic process comprises an H₂ oxidation reaction (HOR). In some embodiments, the HOR takes place at the anode of a fuel cell, e.g., an AEMFC. In some embodiments, the inventive alloy and electrocatalyst offer desirable activity toward the HOR reaction in alkaline media.

In some embodiments, the electrocatalytic process comprises both HOR and ORR.

In some embodiments, the electrocatalytic process does not comprise use of a platinum (Pt)-containing catalyst. In some embodiments, the electrocatalytic process does not comprise use of a platinum (Pt)-containing catalyst for the HOR reaction.

In some embodiments, the electrocatalytic process comprises a hydrogen evolution reaction. In some embodiments, the inventive alloy or catalyst catalyzes the hydrogen evolution reaction. In some embodiments, the hydrogen evolution reaction is performed in alkaline media.

### Examples

The invention will now be illustrated, but not limited, by reference to the specific embodiments described in the following examples.

Synthesis of Carbon Supported Nanoparticles.

Electrocatalyst nanoparticles were prepared according to embodiments of the invention and comparative non-inventive embodiments. A series of Vulcan XC-72R supported IrRu (IrRu/C), IrPd (IrPd/C) and IrPdRu (IrPdRu/C) nanoparticles with different molar ratios, as well as pure metal catalysts such as Pt/C, Ir/C, Pd/C and Ru/C, were synthesized by a wet-impregnation method and subsequent forming gas reduction. More particularly, IrPdRu, IrPd, IrRu, Ir, Pd, Ru and Pt nanoparticles supported Vulcan XC-72R with a metal loading of 20 wt % were synthesized by a wet impregnation method and forming gas reduction. Certain amounts of metal chlorides (for Ir, Ru and Pt catalysts) or metal nitrates (for pure Pd catalysts) were dissolved in 10 mL water in a beaker (for PdCl₂, 0.1 M HCl solution was used). Then 40 mg Vulcan XC-72R were added to the solution. After 30 min of ultrasonication, the solution was heated and magnetically-stirred on a heating plate to form a slurry. The slurry was then ultrasonicated for 10 min. Afterwards, the slurry was dried at 60° C. in the air overnight. Finally, the dried powder was reduced and annealed in a flow furnace under a forming gas atmosphere (5% H₂, 95% Ar, Airgas, Ultrapure) at different temperatures (shown in Table I) for 2 hours. The resulting nanoparticle size increases with the increasing annealing temperatures. Accordingly, reduction temperatures were selected to yield relatively uniform nanoparticle sizes of about 3 nm, so as to avoid possible “size effects”. The flow furnace temperature was raised at a heating rate of 3 K/min. This synthesis route can provide surfactant-free carbon supported catalyst nanoparticles.

TABLE I
Annealing temperatures and properties of electrocatalyst nanoparticles

| | | Annealing | Particle | Lattice | | Mass activity | Specific activity | Exchange |
|---|---|---|---|---|---|---|---|---|
| | | temperature | size | parameter | E_{1/2} | (mA μgₘₑₜₐₗ⁻¹) | (mA cmₘₑₜₐₗ⁻²) | current density |
| Ex# | Sample | (° C.) | (nm) | (nm) | (V) | at 0.01 V | at 0.01 V | (mA cmₘₑₜₐₗ⁻²) |
| 1 | Pt/C | 225 | 3.4 ± 0.6 | 0.3922 | 0.033 | 0.18 ± 0.01 | 0.22 ± 0.01 | 0.48 ± 0.03 |
| 2 | Pd/C | 100 | 3.6 ± 0.2 | 0.3903 | 0.20 | 0.008 ± 0.001 | 0.006 ± 0.001 | 0.025 ± 0.004 |
| 3 | Ir/C | 475 | 3.2 ± 0.2 | 0.3839 | 0.05 | 0.12 ± 0.01 | 0.15 ± 0.01 | 0.40 ± 0.03 |
| 4 | Ru/C | 300 | 3.4 ± 0.4 | 0.2706 | — | 0.04 ± 0.005 | 0.03 ± 0.005 | 0.08 ± 0.01 |
| | | | | 0.4257 | | | | |
| 5 | Ir₉Ru₁/C | 465 | 3.6 ± 0.2 | 0.3836 | 0.018 | 0.37 ± 0.02 | 0.45 ± 0.03 | 0.9 ± 0.09 |
| 6 | Ir₇Ru₃/C | 460 | 3.3 ± 0.2 | 0.3826 | 0.020 | 0.31 ± 0.02 | 0.34 ± 0.03 | 0.57 ± 0.04 |
| 7 | Ir₃Ru₇/C | 350 | 3.4 ± 0.5 | 0.2710 | 0.018 | 0.37 ± 0.02 | 0.31 ± 0.03 | 0.57 ± 0.05 |
| | | | | 0.4289 | | | | |
| 8 | Ir₁Ru₉/C | 325 | 2.7 ± 0.3 | 0.2706 | 0.031 | 0.18 ± 0.01 | 0.11 ± 0.01 | 0.22 ± 0.02 |
| | | | | 0.4285 | | | | |
| 9 | Ir₉Pd₁/C | 420 | 3.0 ± 0.2 | 0.3845 | 0.026 | 0.21 ± 0.01 | 0.23 ± 0.02 | 0.48 ± 0.03 |
| 10 | Ir₈Pd₁Ru₁/C | 435 | 3.3 ± 0.4 | 0.3834 | 0.025 | 0.23 ± 0.02 | 0.25 ± 0.03 | 0.5 ± 0.06 |
| 11 | Ir₆Pd₁Ru₃/C | 460 | 3.0 ± 0.3 | 0.3834 | 0.019 | 0.34 ± 0.02 | 0.31 ± 0.03 | 0.56 ± 0.06 |
| 12 | Ir₃Pd₁Ru₆/C | 375 | 3.4 ± 0.5 | 0.2711 | 0.018 | 0.34 ± 0.02 | 0.28 ± 0.03 | 0.6 ± 0.05 |
| | | | | 0.4325 | | | | |
| 13 | Ir₁Pd₁Ru₈/C | 350 | 3.1 ± 0.3 | 0.2708 | 0.034 | 0.15 ± 0.01 | 0.10 ± 0.04 | 0.24 ± 0.03 |
| | | | | 0.4293 | | | | |

*Where, as in Table I, alloy element subscripts sum 10 instead of 100, their value should be multiplied by 10 in order to determine the atomic % of the element in the alloy (e.g., sample Ir₆Pd₁Ru₃/C from Table I is a carbon-supported alloy Ir₆₀Pd₁₀Ru₃₀).

Electrode Preparation.

First, a catalyst ink was prepared by mixing 1.25 mg catalyst power (electrocatalyst nanoparticles), 3.75 mg Vulcan XC-72R, 3.98 mL Millipore water, 1 mL isopropanol and 40 μL Nafion solution (5 wt %, Fuel Cell Store), and subsequent sonication for 15 min. A glass carbon rotating disk electrode (RDE) with a diameter of 6 mm was polished with 1 μm diamond paste (Buehler), and then rinsed with acetone and Millipore water. Afterwards, 20 μL catalyst ink was pipetted onto the GC electrode, and subsequently dried in the air. An evenly dispersed thin film of catalyst was formed on the GC electrode with a catalyst loading of 3.5 μgₘₑₜₐₗ/cm².

Electrochemical Tests.

Electrochemical experiments were carried out with a WaveDriver 20 Bipotentiostat/Galvanostat, and AfterMath software (Pine Research Instrumentation). A three-electrode electrochemical cell made of Kel-F was used for alkaline media to avoid contamination from glass. An AFMSRCE Rotator (Pine Research Instrumentation) was used for H₂ oxidation and evolution measurements. A glassy carbon (GC) rotating disk electrode with a diameter of 6 mm was used as working electrode. The GC electrode was polished with 1 μm diamond paste and then rinsed with acetone and Milipore water. A homemade Ag/AgCl (1M NaCl) electrode was used as the reference electrode, and all potentials are referred to a RHE (0.1 M KOH). The supporting electrolyte was prepared using Millipore water (18.2 MΩ·cm) and potassium hydroxide (99.99%, Sigma-Aldrich). H₂ (high purity) were obtained from Airgas. Before measurements, all solutions were deaerated with high-purity Ar (Airgas). All experiments were carried out at room temperature (20±1° C.). The potential was scanned in the positive-going direction.

X-Ray Diffraction.

The prepared catalysts were characterized by powder XRD in a Rigaku Ultima VI diffractometer with a Cu K_{α} source. Data were collected at a scan rate of 5°/min and with an increment of 0.02.

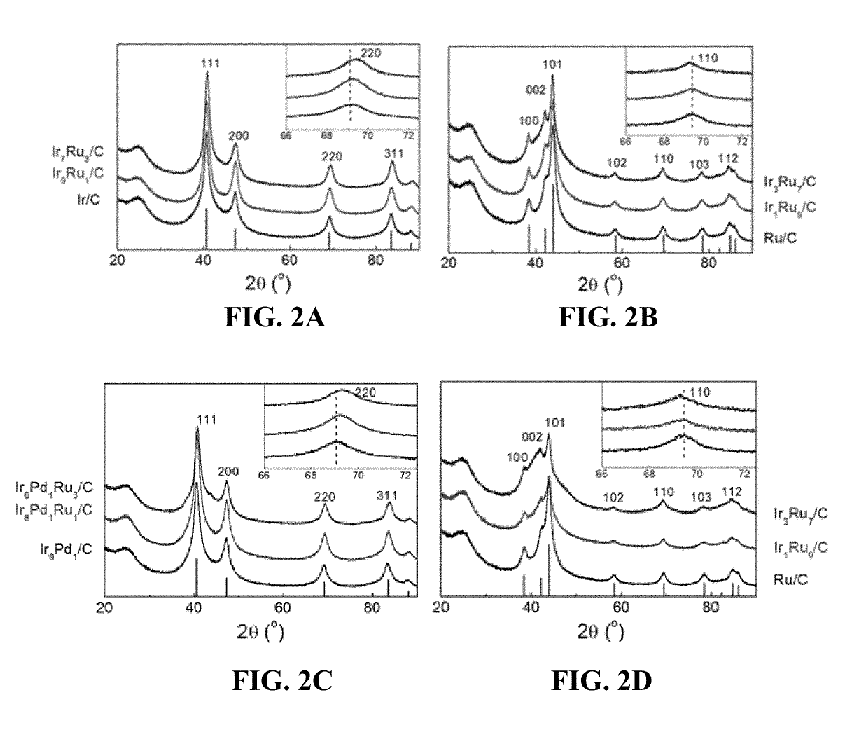

FIGS. 2A-D present X-ray diffraction data for a series of inventive electrocatalyst nanoparticles from Table I, which are compared to pure metal nanoparticle catalysts. Ir(Pd)Ru/C catalysts with high Ir content exhibit an fcc structure, whereas they have a hcp structure for high Ru content. The lattice parameters of Ir(pd)Ru/C alloy nanoparticles as well as pure metal catalysts—Ir/C, Pd/C, Ru/C and Pt/C, are presented in Table I, and are consistent with the calculated lattice parameters from averaging atomic sizes. Pd is slightly larger than Ir, while Ru is slightly smaller than Ir. Therefore, the lattice parameters of the catalysts slightly increase, when Ir is alloyed with Pd. In contrast, they decrease, when alloying with Ru. The mean crystallite sizes were evaluated from diffraction peaks in the 2θ range of 50-90° C., to avoid the overlap with carbon support diffraction peaks in the range between 20 and 50°. The mean nanoparticle sizes, estimated from a line width analysis, are presented in Table I. These nanoparticles have an average size of about 3 nm.

Transmission Electron Microscopy.

TEM was performed using a FEI Tecnai T-12 Spirit operated at 120 kV, which is equipped with a LaB6 filament, single and double tilt holder, a SIS Megaview III CCD camera, and a STEM dark field and bright field detector. The mean nanoparticle size (see Table I) was also determined from TEM measurements. The nanoparticles are well dispersed on the carbon support with an average size of about 3.7 nm, which is consistent with XRD measurements.

Electrocatalyst Activity.

The activity of the electrocatalyst embodiments for the HOR in alkaline media was evaluated by rotating disk electrode (RDE) voltammetry. A thin layer of catalyst was deposited on a diamond paste polished glassy carbon (GC) electrode with a diameter of 6 mm by pipetting 20 μL catalyst ink and subsequently drying in air. A very low loading of 3.5 μgₘₑₜₐₗ/cm² was used to evaluate the activity of catalysts for the HOR. As a starting point, pure metal catalysts—Pt/C, Ir/C, Pd/C and Ru/C were first studied for the HOR in 0.1 M KOH.

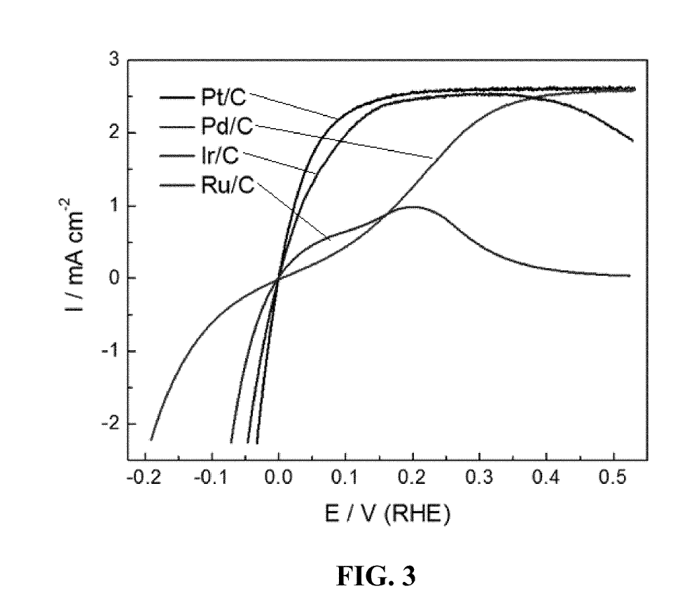

RDE voltammograms of Pt/C, Pd/C, Ir/C and Ru/C in H₂ saturated 0.1 M KOH are compared in FIG. 3. HOR kinetics on Pt/C and Ir/C are faster than on Ru/C and Pd/C. This is in agreement with that H adsorption/desorption processes on Pt/C and Ir/C are more reversible than on Ru/C and Pd/C. Among all studied pure metal catalysts, Pt/C was the most active, while Pd/C was the least active. Since Ru/C and Ir/C surfaces are easily oxidized, and are blocked by oxides at relatively positive potentials, the diffusion limited current cannot be reached on them, particularly on Ru/C. The Tafel slopes for Pt/C, Ir/C and Pd/C is close to 120 mV, which suggests that the oxidation of adsorbed H atoms on these three catalysts is the rate-determining step. The surface oxidation of Ru/C gives rise to a much larger Tafel slope.

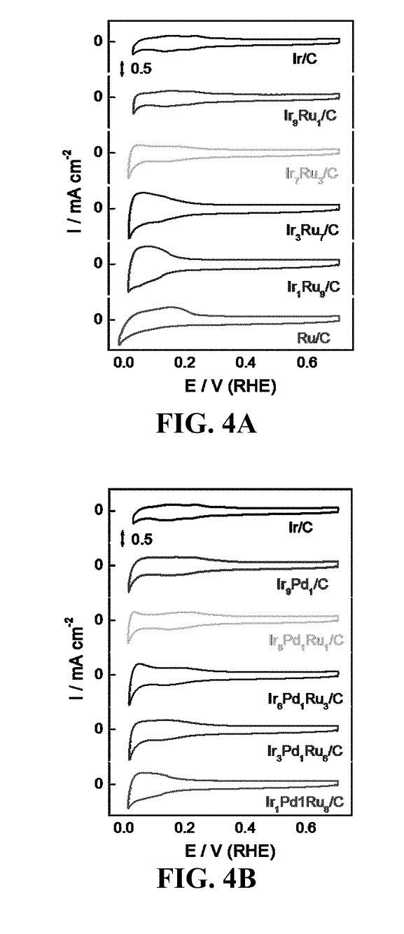

Cyclic voltammograms (CVs) of carbon-supported Ir(Pd)Ru electrocatalyst alloy embodiments from Table I in 0.1 M KOH are compared in FIGS. 4A and 4B. Ir alloying with Ru and/or Pd results in a pair of new peaks occurring at ca. 0.05V, which are related to H adsorption/desorption on Ru and/or Pd sites, and appears reversible. This suggests that H adsorption/desorption processes on Ru and/or Pd sites of alloys are significantly enhanced. For these alloy catalysts, H adsorption/desorption peaks are shifted negatively when compared to Ir/C, and become more reversible when compared to Ru/C and Pd/C. As a result, HOR kinetics on these alloy catalysts are significantly accelerated.

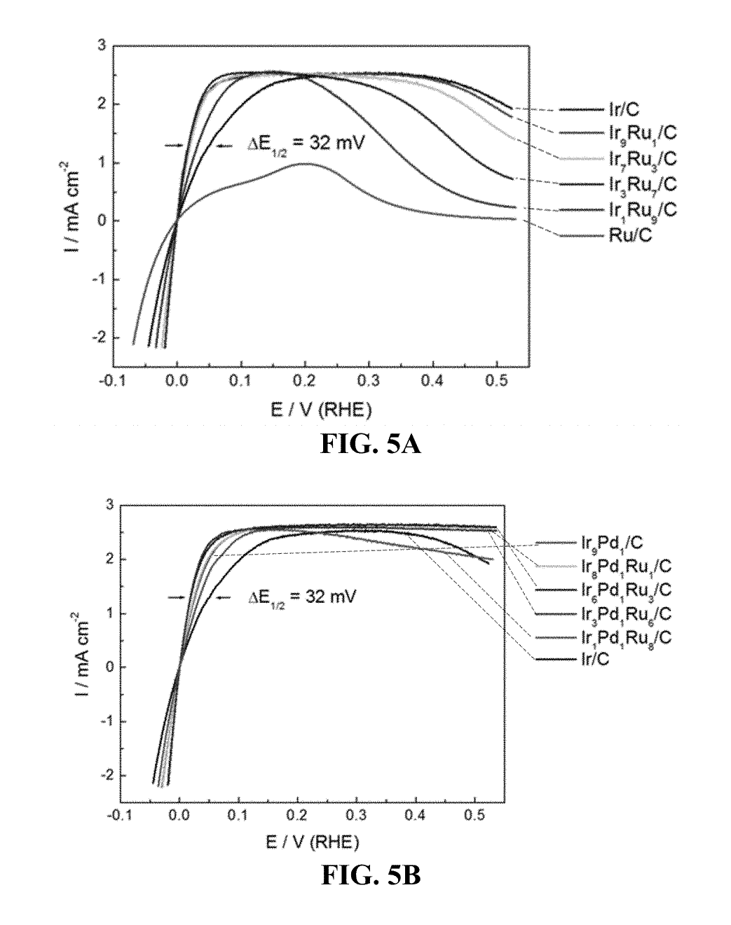

FIGS. 5A and 5B show RDE voltammograms for a series of Ir(Pd)Ru/C catalysts in H₂ saturated 0.1 M KOH, respectively. All studied IrRu/C alloy catalysts were superior to Ir/C, Ru/C, and even Pt/C for HOR. The half-wave potentials for Ir₉₀Ru₁₀/C, Ir₇₀Ru₃₀/C, and Ir₃₀Ru₇₀/C were ca. 32 mV or 15 mV negatively shifted, when compared to Ir/C or Pt/C, respectively. Similarly, all studied Ir₉₀Pd₁₀/C and IrPdRu alloy catalysts exhibited a higher activity than Ir/C, Ru/C and Pd/C. The half-wave potentials for Ir₆₀Pd₁₀Ru₃₀/C and Ir₃₀Pd₁₀Ru₆₀/C were also ca. 32 mV or 15 mV negatively shifted, when compared to Ir/C or Pt/C, respectively. Compared to IrRu/C catalysts, IrPdRu/C catalysts were active over a larger potential region.

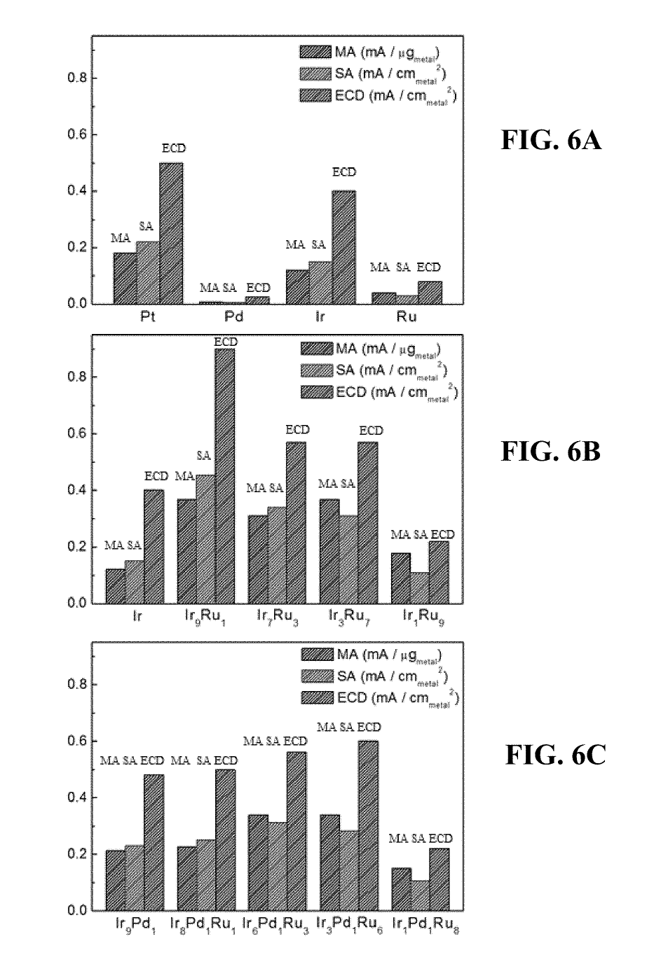

From FIGS. 5A and 5B, the mass activity (MA), the specific activity (SA) and the exchange current density (ECD) were determined and are presented in FIGS. 6A-C and Table I. Since HOR kinetics on the alloy catalysts is very fast, resulting in a very small kinetic region, the Tafel plot analysis cannot be applied here. With respect to the MA, the SA and the ECD, Ir₉Ru₁/C exhibited the highest activity for the HOR among all studied pure metals such as Pt/C, Pd/C, Ir/C and Ru/C, and Ir₁₀₋ₓRuₓ/C, Ir₉Pd₁/C and Ir₉₋ₓPd₁Ruₓ/C catalysts. As for the ECD, Ir₉Ru₁/C, Ir₇Ru₃/C, Ir₃Ru₇/C, Ir₉Pd₁, Ir₈Pd₁Ru₁/C, Ir₆Pd₁Ru₃/C and Ir₃Pd₁Ru₆/C were found to be more active than Ir/C and Pt/C. As for the MA, all alloy catalysts were more active than pure Ir catalysts. The MA of Ir₃Ru₇/C, Ir₆Pd₁Ru₃/C and Ir₃Pd₁Ru₆/C at 0.01V vs. RHE was found to be ca. 2 times higher than Pt/C, 3 times higher than Ir/C, and 9 times higher than Ru/C (FIGS. 6A-C, and Table I). For practical applications, the MA is normally used to evaluate the activity of catalysts. As for the MA, Ir₃Ru₇/C, Ir₆Pd₁Ru₆/C and Ir₃Pd₁Ru₆/C show a comparable activity, when compared to Ir₉Ru₁/C, and are ca. 2 times more active than Pt/C. In particular, Ir₃Ru₇/C and Ir₃Pd₁Ru₆/C are much less expensive than Pt/C and Ir/C, and thus are quite promising as HOR catalysts for alkaline fuel cells.

In alloy catalyst embodiments, Pd is less oxophilic than Ir, while Ru is more oxophilic than Ir. Both Pd and Ru are less active than Ir for the HOR in alkaline media. However, Pd or Ru alloying with Ir significantly enhances HOR activity in alkaline media. Therefore, the oxophilic effect cannot fully explain the observed activity enhancement of IrPd/C and IrRu/C. H adsorption/desorption processes on Ru/C and Pd/C occur at lower potentials than on Ir/C. However, their kinetics are very slow, as indicated by the irreversibility. In contrast, H adsorption/desorption kinetics on Ir/C are faster than for Ru/C and Pd/C, but their potentials are more positive than on Ru/C and Pd/C. In the alloys, a pair of small reversible H adsorption/desorption peaks occurs at around 0.05 V, which is related to H adsorption on Ru or Pd sites of the alloys, but their kinetics are much faster than on pure metals (FIGS. 4A and 4B). This suggests that Ir can facilitate H adsorption/desorption processes on Ru and Pd sites in the alloys. H binding energy is often related to the activity of catalysts in so-called volcano plots. Since the H binding energy on Ru and Pd is higher than on Ir, Ru and Pd-alloying with Ir could decrease the H bond energy. The catalytic effect can thus be attributed to the weakening of H bonding on Pd and Ru when alloying with Ir.

Stability Test.

The stability of Ir₃Ru₇/C and Ir₃Pd₁Ru₆/C was tested under the very tough condition—potential cycling between 0 and 1 V, which is much beyond the working condition in fuel cells—around 0 V vs. RHE. After 1000 cycles, the surface area decreased slightly, however, these two catalysts still exhibit a comparable or even higher activity, when compared to the intact catalysts, suggesting that they are quite stable and durable.

These examples establish that a series of Ir(Pd)Ru/C nanoparticle electrocatalysts as well as pure metals electrocatalysts were successfully synthesized using a wet-impregnation method and subsequent forming gas reduction. The nanoparticles were uniformly dispersed on carbon black with a mean size of about 3 nm. RDE studies show that IrPd/C, IrRu/C and IrPdRu/C catalysts exhibit enhanced activity for the HOR, when compared to Ir/C, Pd/C and Ru/C, and even Pt/C. Among tested embodiments, Ir₃Ru₇/C and Ir₃Pd₁Ru₆/C are superior to Pt/C and Ir/C for the HOR in alkaline media. They are also much lower in cost than Pt/C and Ir/C, and exhibit long-term stability and durability, and thus are promising materials for, e.g., anode catalysts for alkaline fuel cells applications.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), “contain” (and any form contain, such as “contains” and “containing”), and any other grammatical variant thereof, are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a composition or article that “comprises”, “has”, “includes” or “contains” one or more features possesses those one or more features, but is not limited to possessing only those one or more features.

As used herein, the terms “comprising,” “has,” “including,” “containing,” and other grammatical variants thereof encompass the terms “consisting of” and “consisting essentially of.”

The phrase “consisting essentially of” or grammatical variants thereof when used herein are to be taken as specifying the stated features, integers, steps or components but do not preclude the addition of one or more additional features, integers, steps, components or groups thereof but only if the additional features, integers, steps, components or groups thereof do not materially alter the basic and novel characteristics of the claimed composition, device or method.

All publications cited in this specification are herein incorporated by reference as if each individual publication were specifically and individually indicated to be incorporated by reference herein as though fully set forth.

Subject matter incorporated by reference is not considered to be an alternative to any claim limitations, unless otherwise explicitly indicated.

Where one or more ranges are referred to throughout this specification, each range is intended to be a shorthand format for presenting information, where the range is understood to encompass each discrete point within the range as if the same were fully set forth herein.

While several aspects and embodiments of the present invention have been described and depicted herein, alternative aspects and embodiments may be affected by those skilled in the art to accomplish the same objectives. Accordingly, this disclosure and the appended claims are intended to cover all such further and alternative aspects and embodiments as fall within the true spirit and scope of the invention.

1. An alloy of formula (I):
Ir_{z}PdₓRu_{y} (I),
wherein x is the atomic % of palladium (Pd) present, y is the atomic % of ruthenium (Ru) present, Z is the atomic % of iridium (Ir) present, and:
0≤x≤20;
10≤y≤90; and
10≤z≤90.

2. The alloy according to claim 1, having the formula (Ia):
Ir_{z}Ru_{y} (Ia).

3. The alloy according to claim 1, wherein x>0.

4. The alloy according to claim 3, wherein x>5.

5. The alloy according to claim 1, wherein:
0<x≤20;
30≤y≤60; and
30≤z≤60.

6. The alloy according to claim 1, wherein the alloy is a single phase alloy.

7. The alloy according to claim 6, having a face centered cubic (FCC) structure or a hexagonal close packed (HCP) structure.

8. (canceled)

9. An electrocatalyst comprising the alloy according to claim 1.

10. An electrocatalyst according to claim 9, wherein said electrocatalyst is in the form of an electrocatalyst nanoparticle.

11. The electrocatalyst nanoparticle according to claim 10, wherein at least 99 wt % of the nanoparticle consists of the alloy according to formula (I).

12. (canceled)

13. (canceled)

14. A plurality of electrocatalyst nanoparticles according to claim 10, having an average size of 2 to 5 nm.

15. A catalyst for an anode of an alkaline-exchange membrane fuel cell, wherein the catalyst comprises a plurality of electrocatalyst nanoparticles according to claim 11, and wherein said electrocatalyst nanoparticles are carbon-supported.

16. The catalyst according to claim 15, having, at 0.01V:
a mass activity (MA) of at least 0.15 mA/μgₘₑₜₐₗ; or
a specific activity (SA) of at least 0.10 mA/cmₘₑₜₐₗ²; or
an exchange current density (ECD) of at least 0.20 mA/cmₘₑₜₐₗ².

17. (canceled)

18. (canceled)

19. The catalyst according to claim 15, having a half-wave potential (E_{1/2}) of at least 0.015 V.

20. The catalyst according to claim 15, having a half-wave potential (E_{1/2}) of at least 0.034 V.

21. (canceled)

22. An electrochemical device comprising the electrocatalyst nanoparticle according to claim 10.

23. (canceled)

24. (canceled)

25. The electrochemical device according to claim 22, wherein the electrochemical device is an alkaline-exchange membrane fuel cell (AEMFC) comprising:
an anode comprising the electrocatalyst nanoparticle according to claim 10;
a cathode; and
an alkaline exchange membrane (AEM) configured to transport hydroxide ions from the cathode to the anode.

26. The AEMFC according to claim 25, wherein the AEMFC is configured to use, as a cathode oxidant gas, pure oxygen or air, and wherein the AEMFC is configured to use, as fuel, hydrogen.

27. An electrocatalytic process, wherein said process comprises use of an electrocatalyst according to claim 9.

28. The electrocatalytic process according to claim 27, wherein the electrocatalyst is in the form of a plurality of electrocatalyst nanoparticles, wherein at least 99 wt % of the nanoparticles consist of the alloy according to formula (I), wherein the process comprises catalyzing an H₂ oxidation reaction (HOR), and wherein
the HOR is performed in alkaline media; or
the HOR is performed at the anode of an alkaline-exchange membrane fuel cell.

29. (canceled)

30. (canceled)
